(19) United States
(12) Patent Application Publication
(10) Pub. No.: US 2011/0038787 A1
(43) Pub. Date: Feb. 17, 2011

(54) PARTITION AND TRANSPORTATION OF ENCAPSULATED ATOMS

(75) Inventor: Quan Wang, Winnipeg (CA)

Correspondence Address: SCHWEGMAN, LUNDBERG & WOESSNER, P.A., P.O. BOX 2938, MINNEAPOLIS, MN, 55402, US

(73) Assignee: Technology Transfer Office, University of Manitoba, Winnipeg (CA)

(21) Appl. No.: 12/831,008

(22) Filed: Jul. 6, 2010

Related U.S. Application Data
(60) Provisional application No. 61/223,232, filed on Jul. 6, 2009.

(51) Int. Cl. D01F 9/12; B82Y 40/00; B82Y 99/00; B82Y 15/00

(52) U.S. Cl. 423/447.2; 423/447.1; 977/742; 977/962; 977/842

(57) ABSTRACT

A system includes a carbon nanotube and a torsion device. The torsion device is coupled to the carbon nanotube. The torsion device is configured to apply torsion to the carbon nanotube.

### CLAIM OF PRIORITY

This patent application claims the benefit of priority, under 35 U.S.C. Section 119(e), to Quan Wang, U.S. Provisional Patent Application Ser. No. 61/223,232, entitled “PARTITION AND TRANSPORTATION OF ENCAPSULATED ATOMS,” filed on Jul. 6, 2009 (Attorney Docket No. 3035.002PRV), which is hereby incorporated by reference herein in its entirety.

### BACKGROUND

Currently available technology for partitioning and transporting atoms is inadequate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates partition of atoms using a carbon nanotube.

FIGS. 1A-1F illustrate a sequence of images of a carbon nanotube.

FIGS. 2A and 2B illustrate atom loading in a tube.

FIG. 2C illustrates variations of van der Waals potentials corresponding to

FIGS. 2A and 2B.

### DETAILED DESCRIPTION

The surface area of carbon nanotubes (CNTs) is large and can be used to form a nanopumping device for atomic transportation. Atomic and molecular transportation by CNTs in torsion can be used in the areas of nanorobotices, helium energetics, medical drug delivery, micropumps, microarays, atom optics, chemical process control, and molecular medicine. The technology solves the fundamental problem of the transportation of atoms and molecules encapsulated in a CNT subjected to both compression and torsion loading via molecular dynamics simulations. Dependence of the size of the CNT, the type of loading and the loading rate on the effectiveness and efficiency of transportation of the encapsulated atoms in the CNT is investigated. In addition, the effect of temperature used in the dynamic process on the atomic transportation is also explored. Van der Waals potential is calculated to measure the driving force for the transportation.

Commercial applications of the technology include microflow in microcapillaries in the area of nanorobotices, helium energetics, medical drug delivery, micropumps, microarays, atom optics, chemical process control, and molecular medicine.

Torsion can be applied to a carbon nanotube using a torsional pendulum or other such device. A torsional pendulum can be fabricated using an individual single-walled carbon nanotube. The carbon nanotube is used as a torsional spring and mechanical support for a moving part. The moving part can be rotated or deflected by an electric field. Displacement of the moving part can be configured to cause a large and fully elastic torsional deformation of the nanotube. In other examples, a carbon nanotube can be deflected or deformed by application of other fields such as a magnetic field.

Furthermore, oscillations can be excited by the thermal energy of the pendulum, based on a small restoring force associated with the torsional deformation of a single molecule. Diffraction analysis can be used to determine the handedness of the molecule in a device. Such a device can be used to form a nanoelectromechanical system as described herein.

Carbon nanotubes (CNT) can be used in a nanoelectromechanical system application. For example, the large surface area of a CNT allows fabrication of a device for atomic transportation in the areas of nanorobotices, medical drug delivery, micropumps, chemical process control, and molecular medicine.

A carbon nanotubes can be used as a filter for water desalination, petroleum filtration, or kidney dialysis. Filtration efficiency using carbon nanotubes can be improved by managing the driving forces and how those forces are applied.

The present subject matter includes a study of molecular dynamics on atomic partition using carbon nanotubes in torsion. The dependence of the sizes of carbon nanotubes and loading rates of the torsion subjected to the nanotubes on an effective partition of helium and carbon atoms encapsulated in tubes is examined. A carbon nanotube under torsion at a predetermined rate can be used for transporting and partitioning of atoms and molecules.

Carbon nanotubes (CNTs) have a large surface area and smooth wall. A CNT can be used for transporting atoms and molecules. In addition, CNTs can be used for spot welding as well as novel biomedical therapies. The migration of carbon interstitials in CNTs under electron irradiation can be observed. Experimental results show high mobility of carbon atoms inside CNTs and suitability as a pipeline for the transport of carbon atoms.

In addition, CNTs can be used for filtering and used in membranes suitable for water purification or for separation of bio-molecules. CNTs can be used as filters suitable for eliminating components of heavy hydrocarbons from petroleum and for filtering bacterial contaminants from water. In one example, polymerized lipid assemblies can be isolated from the nanotube template. CNT membranes can be configured to exhibit significant ion exclusion—as high as 98% under certain condition, and the chemical inertness of the CNT walls can be used to facilitate special fictionalization of the CNT pore entrance with different functionalities.

In one example, a Rayleigh traveling wave can be used to show the flow and mass selectivity of a mixture of helium and hydrogen atoms using a CNT. In one example, a CNT can be used to complete transportation of helium atoms and hydrogen molecules encapsulated in CNTs in torsion. One aspect of the present subject matter includes a CNT in torsion for partition of helium and carbon atoms.

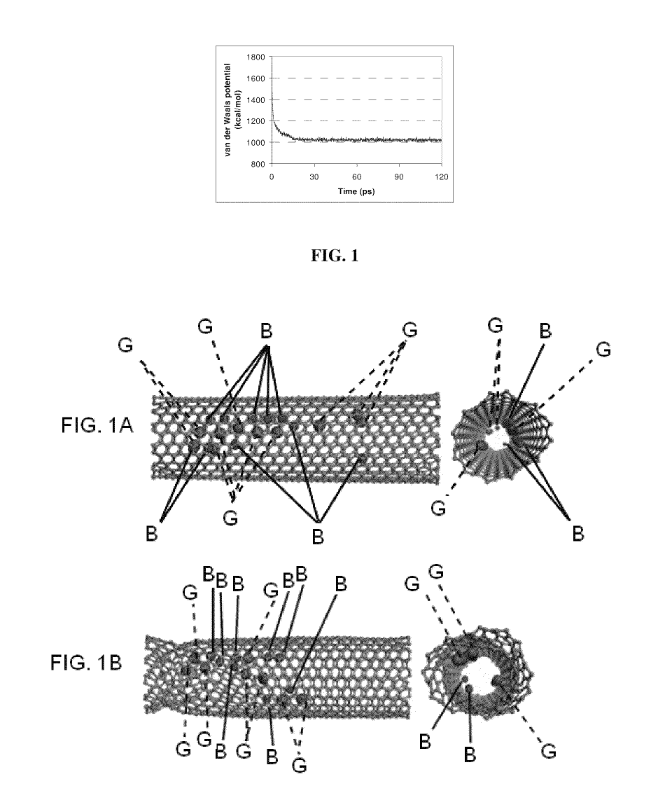

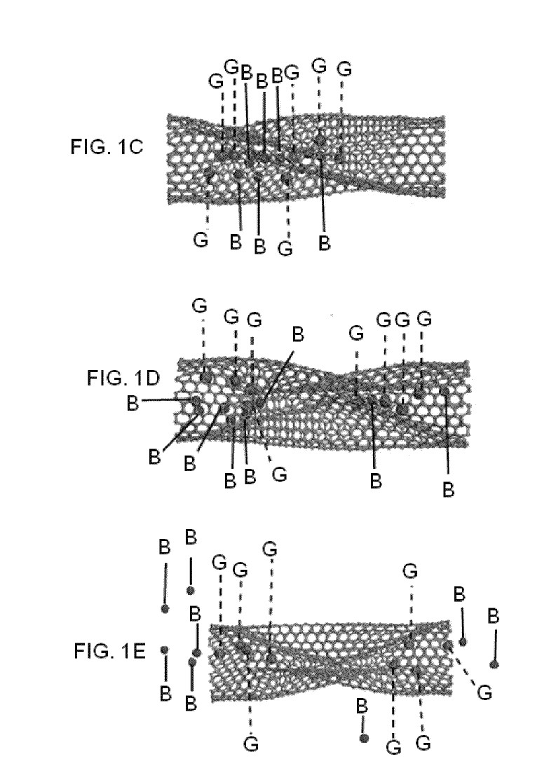

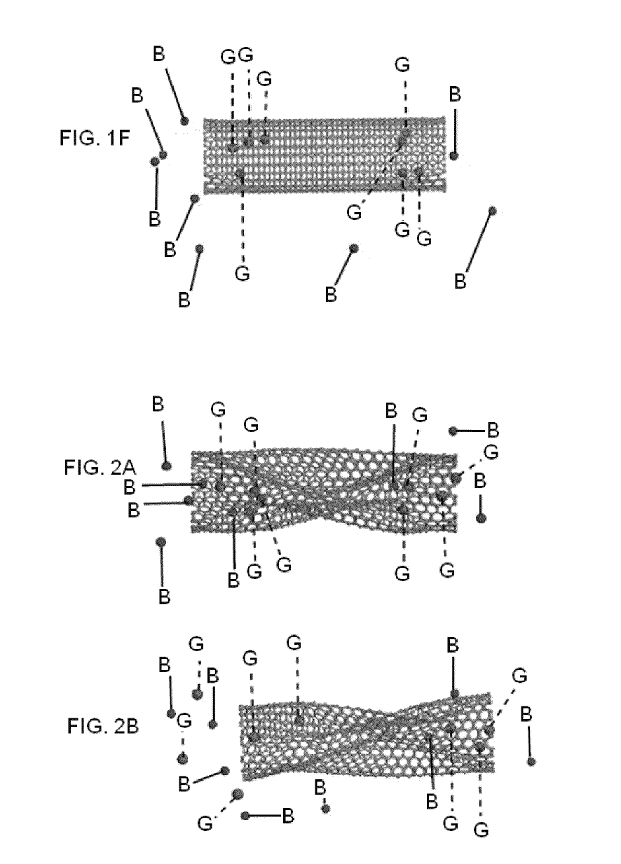

FIG. 1 above illustrates partition of the atoms in a (12,12) CNT of the length of 4.96 nm. The CNT, filled with a mixture of 8 helium in blue (denoted in the figures by solid lead lines having label B) and 8 carbon atoms in green (denoted in the figures by dashed lead lines having label G), is subjected to a torsional angle, 10 degree, statically first. Subsequently, an additional torsional angle, 40 degree, is applied to the tube with the loading rate of 0.873 rad/ps. Snapshots of the atoms and the CNT (including the cross section views in FIGS. 1A-1B). FIG. 1A illustrates the initial moment with all atoms aligned with a half circle pattern in the circumferential direction of the tube. FIG. 1B illustrates completion of the loading process, and shows the initiation of a kink close to the left end of the CNT. FIG. 1C illustrates t=5 ps after the loading process, indicating the kink propagation or expansion along the tube. FIG. 1D illustrates t=20 ps, with the end of the local buckling process and the start of the global buckling state of the tube, revealing the atoms are squeezed along two directions in the tube attributed to the maximal collapse of the kink around the center of the tube. FIG. 1E illustrates t=120 ps, the end of the dynamic process, enlightening all helium atoms pushed out of the tube and leaving all carbon atoms locked inside the tube. FIG. 1F illustrates after the restraints on the two ends are removed, the CNT recovers its original straight shape with all carbon atoms inside the tube to show partition of the atoms. FIG. 1G illustrates variation of van der Waals potential versus the time in the dynamic process.

A (12,12) armchair CNT with the length of 4.96 nm encapsulating 8 helium and 8 carbon atoms is investigated at room temperature by molecular dynamics simulations. The morphology of the tube and the encapsulated atoms after a minimization process is provided in FIG. 1A. A distribution of a half-circular shape of helium and carbon atoms from the cross section view is observed. All the atoms keep almost undisturbed and the tube wall maintains a circular shape at a preliminary torsional angle of 10°. An angle of 40° is applied at the left clamped end of the tube with the rate of 0.873 rad/ps and yields the snapshot of the tube with atoms at the end of the loading process as shown in FIG. 1B. An incident of a kink, a phenomenon of a collapse of the tube wall, locally initiated around the left clamped end is observed because the torsion angle exceeds the critical torsional angle of the tube for the sustainability of a stable circular shape. At this moment, a slight disturbance on the atoms is observed. The snapshot of the system at t=5 ps, that is 5 ps after the torsion loading is applied, is provided in FIG. 1C, in which the kink expansion or propagation is observed. Because of the expansion of the kink, the acceleration on the atoms in the tube is induced accordingly due to van der Waals force interacting between the atoms and the CNT. At this moment, the shrink of the wall has not achieved a maximal extent and the kink has not arrived at the right end of the tube. The snapshot of the system at t=20 ps is provided in FIG. 1D to trace the possible atomic partition in the tube. As shown, the kink occupies the whole tube area at this moment, showing the end of the local buckling process and the occurrence of the global buckling state of the tube. At the global buckling state, the most severe collapse of the tube wall appears around the center of the tube because of the restraints on the two ends. As such, the induced van der Waals force propels the atoms to move towards two directions, two helium and four carbon atoms to the right and six helium and four carbon atoms to the left. Since the mass of a carbon atom is almost three times of a helium atom, the faster motion of all helium atoms and the inertness of carbon atoms during the acceleration process can be observed. Meanwhile, the helium atoms are found to be able to pass by carbon atoms and lead the motions towards the two directions owing to the larger hollow space of the (12,12) CNT. The original mixed pattern of the atoms is therefore violated and the partition of atoms initiates at the moment. FIG. 1E shows the snapshot of the system at t=120 ps, the end of the molecular dynamics process. During the period from t=20 ps to t=120 ps, the helium atoms continue to move to the two directions while the carbon atoms appear to move slowly and vibrate around their locations. It is observed at the moment, t=120 ps, all the eight helium atoms are pushed out of the tube, two from the right end and six from the left end of the tube, and all the eight carbon atoms are locked in the tube. After the restriction on the two clamped ends of the CNT is released, the CNT recovers its original straight shape, owing to the recovery characteristic of the material, with the eight carbon atoms remaining in the tube as shown in FIG. 1F.

To quantitatively illustrate the role of van der Waals force during the partition process, the variation of the van der Waals potential from the end of the loading process, t=0 ps, to the end of the dynamic process, t=120 ps, is provided in FIG. 1G. The decrease in the potential represents the energy used for the propulsion of atoms in the tube. The figure reads that the energy of 590 kcal/mol has been used from t=0 ps to t=5 ps for the acceleration of atoms encapsulated in the tube. Such an amount of energy induces the atoms to start flowing in the tube. Furthermore, the decrease of the energy with the amount of 110 kcal/mol from t=5 ps to t=20 ps, though much less than that from the t=0 ps to t=5 ps, further accelerates the motion of the atoms. Both helium and carbon atoms start moving towards two directions due to the occurrence of the severe collapse of the wall around the center of the tube. Because of the mass selectivity, the helium atoms start leading the motion from t=5 ps to t=20 ps. After the moment t=20 ps, the van der Waals potential reaches an asymptotic constant, indicating the occurrence of the global buckling of the tube. Therefore, there is no more driving energy for the motion of all atoms in the tube after this moment. However, the motion of atoms, particularly the motion of helium atoms, is still observed because of the acceleration induced to them before. As such, the helium atoms are squeezed out of the tube and all carbon atoms are left in the tube because of their relative inertness compared to helium atoms. Supplementary information is provided for a whole process of the molecular dynamics simulations from t=5 ps to t=120 ps.

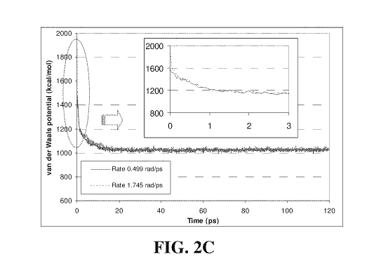

FIG. 2 includes snapshots of the atoms and the (12,12) CNT at t=120 ps.

In FIG. 2A, the tube is subjected to a lower loading rate of 0.499 rad/ps showing an incomplete partition of atoms with three helium and all carbon atoms still locked in the tube. In FIG. 2B, the tube is subjected to a higher loading rate of 1.745 rad/ps indicating extra driving force to push carton atoms out of the tube. FIG. 2C shows variations of van der Waals potential in the dynamic processes at two loading rates. A decrease in the potential occurs to the process at the higher loading rate indicating an extra energy to pump both helium and carbon atoms out of the tube, and a decrease in the potential occurs to the process at the lower rate leading to a partial pump of helium atoms. Incomplete partitions of atoms are therefore observed in both processes.

To further investigate the atomic partition, consider the similar torsional loading process but at two different rates on the tube. FIG. 2A and FIG. 2B illustrate the snapshots of the atoms and the CNT at t=120 ps with the rate of 0.499 rad/ps and 1.745 rad/ps respectively. It is found that only 5 helium atoms are finally pushed out of the tube leaving the other three locked in the tube with all the carbon atoms in FIG. 2A, and three carbon atoms are squeezed out of the tube in FIG. 2B. The partition of atoms is incomplete at either the lower or the higher rate. The variations of van der Waals potentials in the above two scenarios are provided in FIG. 2C. Similarly, it is found that the potential reaches a virtually constant value 1050 kcal/mol around t=20ps showing the initiation of the global buckling at the moment. Variation from t=0 ps to t=3 ps appears on the right upper corner of FIG. 2C. The potentials start at 1880 kcal/mol and 1580 kcal/mol, respectively, at the beginning, and converges to a virtually same value, 1400 kcal/mol, around t=0.4 ps for both the higher rate and the lower rate scenarios. A difference in the driving force for the motion of atoms with the two torsional impacts initiates in a very short period, 0-0.4 ps, shown in the figure, and such a difference is attributed to kink propagation. The lengths of the local kink are read to be 0.49 nm and 0.98 nm for the higher and the lower loading processes respectively. According to elastic beam theory, the wave propagation velocity of a disturbance is inversely proportional to its wavelength. Therefore, it is estimated that the propagation velocity of the kink initiated at higher loading rate is almost twice of the one at lower rate. Since van der Waals potential is released with the kink propagation, the induced acceleration of atoms is higher in the tube at the higher rate. The driving force is either extra or insufficient for atomic partition in a tube at higher or lower rates. Both lead to incomplete partitions.

In summary, atomic partition is realized with a CNT subjected to torsional loading at a proper rate. The effect of CNT size on the effectiveness of the atomic partition is also revealed in a study. Atomic partition using CNTs may lead to new and innovative filtration devices.

A fluid delivery device can be coupled to the carbon nanotube. The fluid delivery device can include a micro-fluidic channel or a nano-fluidic channel. In one example, at least one sample reservoir is coupled to the nanotube. The sample reservoir can be configured to hold a fluid such as a liquid or a gas.

### METHODS

Molecular dynamics simulations can be conducted to investigate the atomic partition of helium and carbon atoms encapsulated in the (12,12) CNT. In simulations, the interatomic interactions are described by the condensed-phased optimized molecular potential for atomistic simulation studies. The ab initio force field can be parameterized and validated using condensed-phase properties. It can also be used in describing the mechanical behaviors of CNTs encapsulating foreign atoms. The potential of a system is expressed as a sum of valence (or bond), cross-terms, and non-bond interactions: Eₜₒₜₐₗ=E_{valence}+E_{crossterm}+E_{non-bond}. The energy of valence, E_{valence}, can be generally accounted for by terms including bond stretching, valence angle bending, dihedral angle torsion, and inversion. The cross terms, E_{crossterm}, account for factors such as bond or angle distortions caused by nearby atoms to accurately reproduce experimental vibrational frequencies. The energy of interactions, E_{non-bond}, between non-bonded atoms is primarily accounted for by van der Waals effect. The dynamics process is conducted to allow the system to exchange heat with environment at a constant temperature. The Andersen method can be used in the thermostat to control the thermodynamic temperature and generate the correct statistical ensemble. For a temperature control, the thermodynamic temperature is kept constant by allowing the simulated system to exchange energy with a ‘heat bath’. Torsion loading is applied through subjecting torsion angle to one of the two clamped ends of the CNT. During the loading process, the time step in the molecular dynamics is chosen to be 0.01 fs to improve the reliability and accuracy of the simulations. To simulate the motion of the CNT and the encapsulated atoms after the torsional loading is applied, the time step is chosen to be 0.2 fs in all the simulations to efficiently describe longer processes, while still satisfying the precision in simulations. The configuration of a CNT encapsulating helium and carbon atoms in FIG. 1A is achieved through a minimizer processor, which enables the atoms in the material to rotate and move relatively to each other to minimize the potential energy.

### ADDITIONAL NOTES

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising
a carbon nanotube; and
a torsion device coupled to the carbon nanotube, the torsion device configured to apply torsion to the carbon nanotube.

2. The system of claim 1 wherein the torsion device includes a pendulum.

3. The system of claim 1 further including a fluid delivery device coupled to the carbon nanotube.

4. The system of claim 1 further including a reservoir coupled to the carbon nanotube.

5. A method comprising:
delivering a sample to a carbon tube; and
exerting a torsion load to the carbon tube.

6. The method of claim 5 wherein delivering a sample to the carbon nanotube includes delivering at least one of a gas and a liquid.

7. The method of claim 5 wherein exerting the torsion load includes applying a field.

8. The method of claim 5 wherein exerting the torsion load includes applying a motive force to the sample.

9. A method comprising:
forming a carbon nanotube; and
coupling a torsion device to the carbon nanotube.

10. The method of claim 9 wherein coupling the torsion device includes providing a torsion pendulum.
